(19) United States
(12) Patent Application Publication
(10) Pub. No.: US 2013/0339067 A1
(43) Pub. Date: Dec. 19, 2013

(54) METHOD AND SYSTEM FOR DETERMINING CASINO GAME AVAILABILITY AND FOR RESERVING CASINO GAME PLACES

(71) Applicant: Lewis Krell, San Francisco, CA (US)

(72) Inventor: Lewis Krell, San Francisco, CA (US)

(21) Appl. No.: 13/527,496

(22) Filed: Jun. 19, 2012

(51) Int. Cl. G06Q 10/02

(52) U.S. Cl. 705/5

(57) ABSTRACT

A computer-implemented system is disclosed for determining casino game availability and reserving one or more places at a casino game. The system includes one or more servers configured to execute computer program components, the computer program components comprising a casino game request component for presenting an interface to a user via a website or other application through which player casino game requests are received, and a reservation component for reserving one or more places at a casino game for one or more players.

### FIELD OF THE INVENTION

The present invention relates to a system and method for determining casino game availability and for reserving places at a casino game.

### BACKGROUND OF THE INVENTION

Casinos are a popular destination for many. Today, they now provide a number of services to its guests such as premium shows, fine dining cuisine, spa treatments, pool lounging and other services. However, casinos offer one main service—gambling. Gambling offers not only the thrill of competition, but an opportunity to win money. Players (i.e., gamblers) have therefore traveled great distances to gamble. Each casino typically offers a number of games such as slot machines and table games. Some of the more popular table games include Black Jack, Roulette, Craps, Poker, and Baccarat. Black Jack, Poker and Baccarat are table games that typically have five to seven seats for players (gamblers). In some cases, a table game can occupy one or more players for hours. Therefore, they are especially popular among groups of individuals like business colleagues, convention attendees and friends. This is why Las Vegas is a popular destination for such groups.

While casinos offer a wide variety of games, there is really no guarantee that a particular game will be available for play. That is, there is no guarantee that a particular casino game will be open for play, will satisfy a player's budgetary constraints and/or will satisfy a player's geographic desires. Further, there is also no guarantee that a particular game is capable of seating a group of players. In fact, there is no guarantee that even a single player will find open seating (i.e., places) at a desired game at any particular time regardless of a player's budgetary and/or geographic constraints. Therefore, players must trek from casino to casino to find an available game (e.g., with open seating at desired betting limits). Players have wandered for hours in an attempt to find available seats at a desired game without luck. In many instances, players have failed to play a desired available game during their entire visit/stay.

It would thus be advantageous to provide systems and methods that will overcome the problems described above.

### SUMMARY OF THE INVENTION

In accordance with an embodiment of the present invention, a system and method is disclosed for determining casino game availability and for reserving places at a casino game.

In accordance with an embodiment of the present invention, a computer-implemented system is disclosed for determining casino game availability and reserving one or more places at a casino game, the system including one or more servers configured to execute computer program components, the computer program components comprising a casino game request component for presenting an interface to a user via a website or other application through which player casino game requests are received and a reservation component for reserving one or more places at a casino game for one or more players.

In accordance with another embodiment of the present invention, a computer-implemented method is disclosed for confirming casino game availability and reserving one or more places at a casino game, wherein the method is implemented in one or more servers configured to executed one or more computer program components, the method comprising executing, on the one or more servers, a computer program component for presenting an interface to a user via a website or other application through which player casino game requests are received and executing, on the one or more servers, a computer program component for reserving one or more places at a casino game for one or more players.

In accordance with yet another embodiment of the present invention, a computer-implemented system is disclosed for determining casino game availability, the system including one or more servers configured to execute one or more computer program steps, the one or more computer program steps comprising processing a player's request for availability of a casino game and searching for a casino game to play corresponding to the player's request.

In accordance with another embodiment of the present invention, a computer-implemented method is disclosed for determining casino game availability and for reserving places at a casino game, wherein the method is implemented in a device configured to execute a plurality of computer program steps, the computer program steps comprising receiving a player's request for availability of a casino game via a browser or other application in the device and sending a request for availability of the casino game corresponding to the player's request.

In accordance with yet another embodiment of the present invention, a computer-implemented system is disclosed for determining casino game availability, the system including one or more servers configured to execute computer program steps, the computer program steps comprising monitoring for availability of a casino game for a player to play and displaying the availability of the casino game to play.

### BRIEF DESCRIPTION OF THE DRAWINGS

FIG. 1 depicts a block diagram of a system for determining casino game availability and for reserving game places at a casino according to an embodiment of the present invention.

FIG. 2 depicts a block diagram of the central system shown in FIG. 1.

FIG. 3 depicts a block diagram of the central casino system of a casino shown in FIG. 1.

FIG. 4 depicts a top perspective view of several table games at a casino shown in FIG. 1.

FIG. 5 depicts a top perspective view of several table games at a casino shown in FIG. 3 in accordance with another embodiment of the present invention.

FIG. 5A depicts an enlarged cross sectional view of the table game shown in FIG. 5.

FIG. 5B depicts an enlarged cross sectional view of the table game shown in FIG. 5 in accordance with another embodiment of the present invention.

FIG. 6 depicts a top perspective view of a table game at the casino shown in FIG. 3.

FIG. 7 depicts a block diagram of the system of FIG. 1 in part illustrating player access points in more detail.

FIG. 8 depicts a flowchart of the high level steps of the application process shown in FIG. 1 in which a player makes a reservation in accordance with the present invention.

FIG. 9 depicts a flowchart of the application process of system in FIG. 1 with respect to central system in accordance with the present invention.

FIG. 10 depicts a flowchart of the high level steps of part of the application process of system in FIG. 1 for casino game availability including seat availability.

FIG. 11 depicts a flowchart of the high level steps of part of the application process of system in FIG. 1 for casino game availability including limit availability.

FIG. 12 depicts a block diagram of a general purpose computer to support the embodiments of the computer-implemented systems and methods including computer components disclosed in this application.

### DETAILED DESCRIPTION OF THE INVENTION

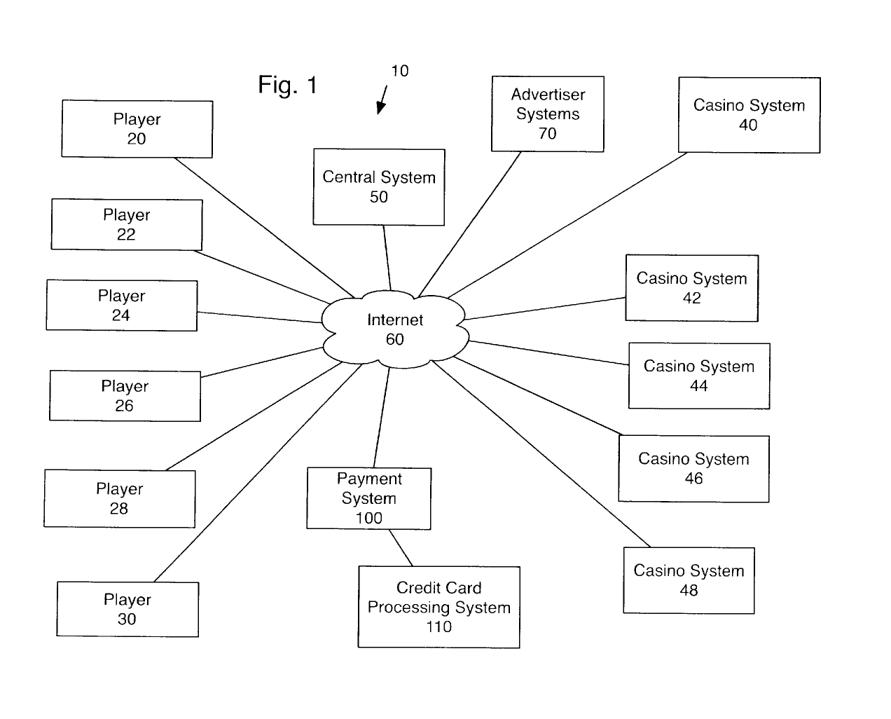

FIG. 1 depicts a block diagram of a system 10 for determining casino game availability and for reserving game places at a casino according to an embodiment of the present invention. Casino game availability includes games that are open for play, games that may satisfy a player's budgetary constraints and/or games that satisfy a player's geographic desires/location as discussed in more detail below. Places are seats or spaces available or vacant for a player to occupy at a particular game. Examples of such games include table games, slots and the like. In FIG. 1, there is shown a plurality of players 20-30 and casino systems 40-48. Players 20-30 are connected to casino systems 40-48 via a communication network such as Internet 60. Players 20-30 and casino systems 40-48 may access the applications on central system 50 via web browser or stand alone application on a mobile device or personal computer as described in more detail below. Examples of these casino systems include Bellagio Casino system, Wynn Casino system, Harrah's Casino system, Flamingo Casino system and Trump Casino system. Planet Hollywood Casino is another. Casinos include resorts, hotels and other establishments that offer games (i.e., gaming services) to players for play. As described in more detail below, central system 50 includes several components for implementing the reservation system. These components are computer programs or software components. To obtain all of the services provided by central system 50 according to the present invention, both players and casinos will register with central system 50.

FIG. 1 also depicts companies that may market or advertise products and services to players 20-30 via Internet 60. These companies together are represented by block 70. FIG. 1 also depicts social networks like Facebook 80 and Twitter 90. Those skilled in the art know that additional social networking sites may be incorporated. Players 20-30 may access such social networks via Internet 60 as well. As will be described in more detail below, players 20-30 may access central system 50 through a web browser or dedicated application via a mobile device, laptop, desktop, tablet or other device that can access Internet 60.

System 10 also includes payment system 100 and credit card processing system 110. Payment system 100 processes both mobile and wired payments. Payment system 100 uses credit card processing system 110 to process credit card payments as known by those skilled in the art. Payment system 100 also process payments by drawing funds from bank accounts as known to those skilled in the art.

Payment system 100 processes payment information made by players 20-30 to reserve places at a casino game. As indicated, payment system 100 uses credit card processing system 110 to ultimately process credit card payments, if credit card payment is the method of payment. Payment system 100 is preferably configured to charge a fee for the processing of reservation payment. The fee may be a flat rate or a percentage of the size of the deposit or full payment for the game place reservation. Processing system 100 may be used to charge both players and casinos to use the system 10 in accordance with the present invention as described in more detail below.

Payment system 100 similarly receives payment information from casino systems 40-48 upon registration, if configured that way. That is, the casinos are preferably charged to register, but the casino may be permitted to register and access player requests without charge. Registration enables a casino to access player's search requests for games. Extra charges may enable a casino to receive preferential treatment when it comes to a player's options for games. Payment system 100 also processes payment information from advertiser systems 70 as known by those skilled in the art. There are other payment and revenue schemes and options for generating revenue as known by those skilled in the art.

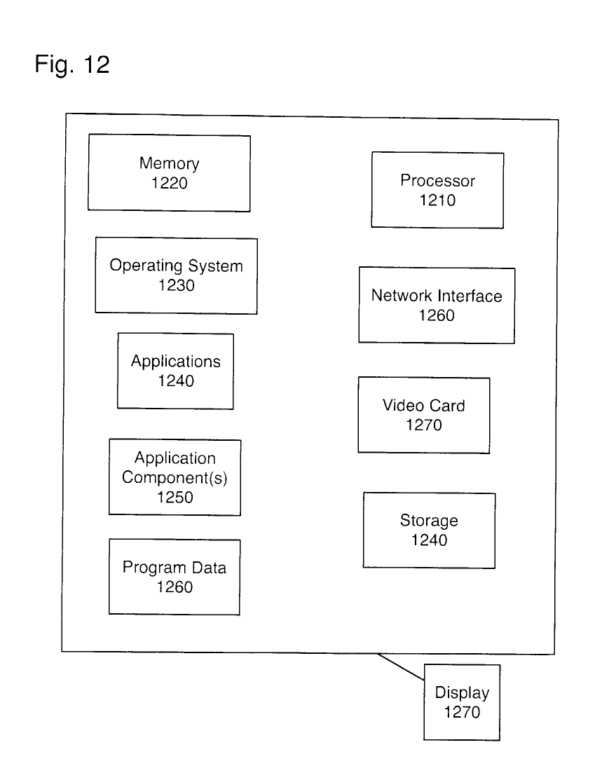

As known to those skilled in the art, central system 50, casino systems 40-48, advertiser systems 70, payment system 100, credit card processing system 110, Facebook 80 and Twitter 90 each include one or more computer servers and displays. Each server includes one or more processors, memory, network interfaces, hard drives, video cards and other conventional components known to those skilled in the art. These servers typically run Unix or Microsoft server as the operating system and the servers include TCP/IP protocol stack (to communicate) as known by those skilled in the art. A representative server is shown in FIG. 12.

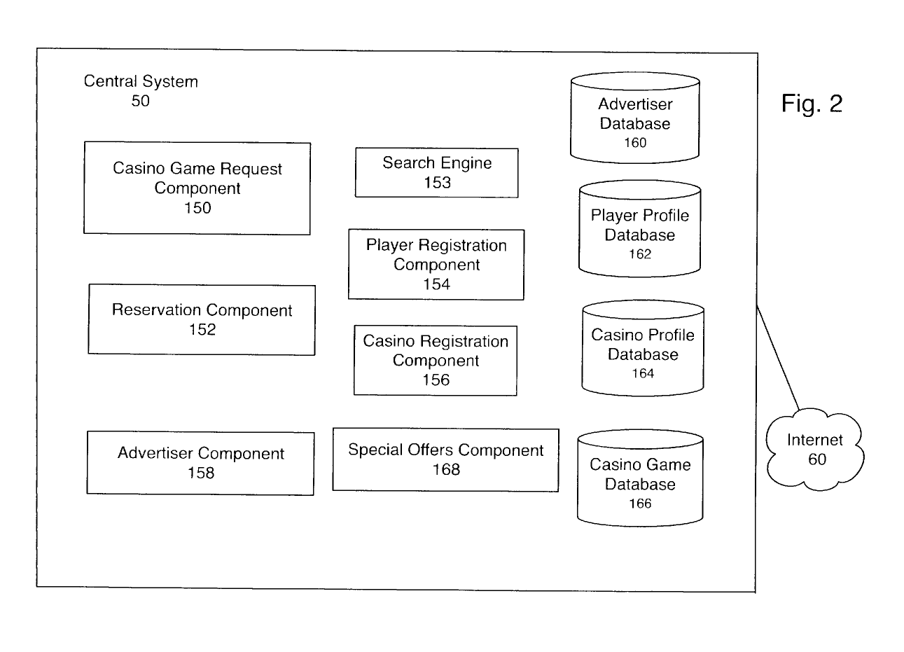

FIG. 2 depicts a block diagram of the central system 50 shown in FIG. 1. Central system 50 includes casino game request component 150 and casino game reservation component 152.

Casino game request component 150 receives a player's request for table or other game places at a casino. Game request component 150 may operate on a web server accessible over Internet 60 by players 20-30. Casino game request component 150 may present an interface to a player via website or another application through which player casino game requests may be received. The other application may be a mobile device application on an iPhone for example or a dedicated application on a personal computer. Casino game request component 150 may utilize search engine 153 for casino game information. Search engine 153 may be a separate component or may be part of casino game request component 150.

Casino game reservation component 152 actually processes and reserves table game places for reservation requests made by a player. Reservations are made for games in which players occupy seats, but reservations may be used for games in which players merely occupy space. For seated games, table game availability and reservations may be made by seat or by table. For example, casino reservation component 152 will permit a player to reserve a table for his/her entire party. In this respect, table reservations may include premium services. Such premium services may include designated waiter/waitress service and food and cocktail services. Casinos may charge extra for a table with premium services. This is described in more detail below. The games are preferably table games but other games may be incorporated as known by those skilled in the art.

Central system 50 further includes player registration component 154 and casino registration component 156. As described in more detail below, a player may register with central system 50. Such registration will be accomplished using registration component 154. Registration will enable a player to receive full benefits from central system 50. Registration information will include for example, player name, address, age, casino game preferences, pricing preferences and payment information in order to create a player profile. Registration information may also include social network information including login user name and password to enable integration with such social network sites (e.g., Facebook and Twitter) and to access Friends and postings. Casino systems 40-48 each will register with central system 50 via casino registration component 156. Such information will include, casino name, eligible games for reservation, payment information and contact details to create a profile of a casino. Central system 50 also includes an advertiser component 158. Advertiser component 158 is configured to register advertisers (for advertiser systems 70) and integrate targeted advertisements to players 20-30 as known to those skilled in the art.

Advertiser profiles and related information will be stored in advertiser database 160. Player profiles will be stored in player profile database 162 and casino profiles will be stored in casino profile database 164. A list of casino games eligible to for player selection is stored in game database 166.

Central system 50 also includes a special offers component 168 for providing and processing special offers to the players.

Casino game request component 150, reservation component 152, advertiser component 168, player registration component 154, casino registration component 156, advertiser component 158, and special offers component 168, each include one or more software modules for execution by one or more servers (with processors within) as known by those skilled in the art.

While central system 50 has been described in detail above, those skilled in the art know that it may contain other components to achieve desired results.

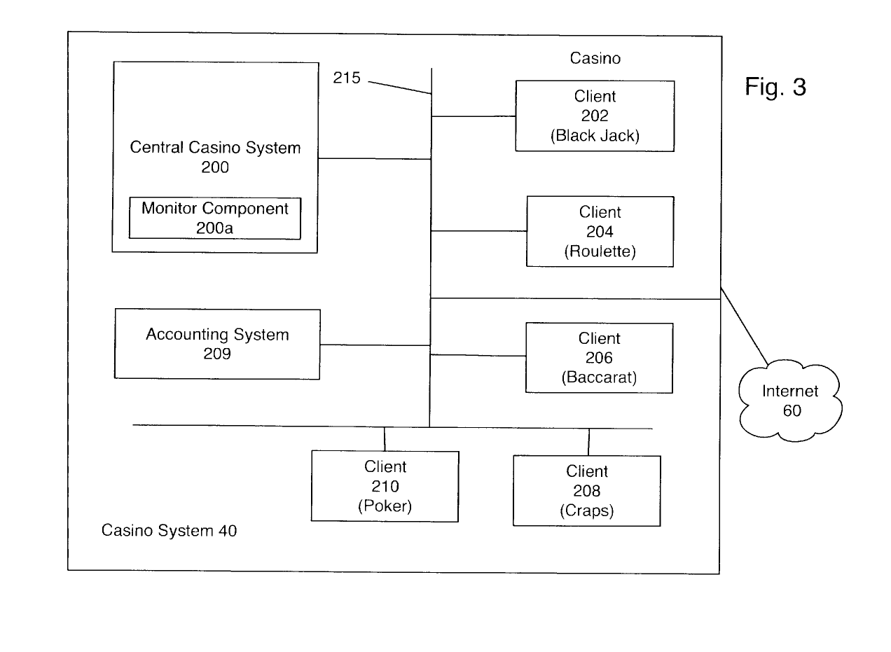

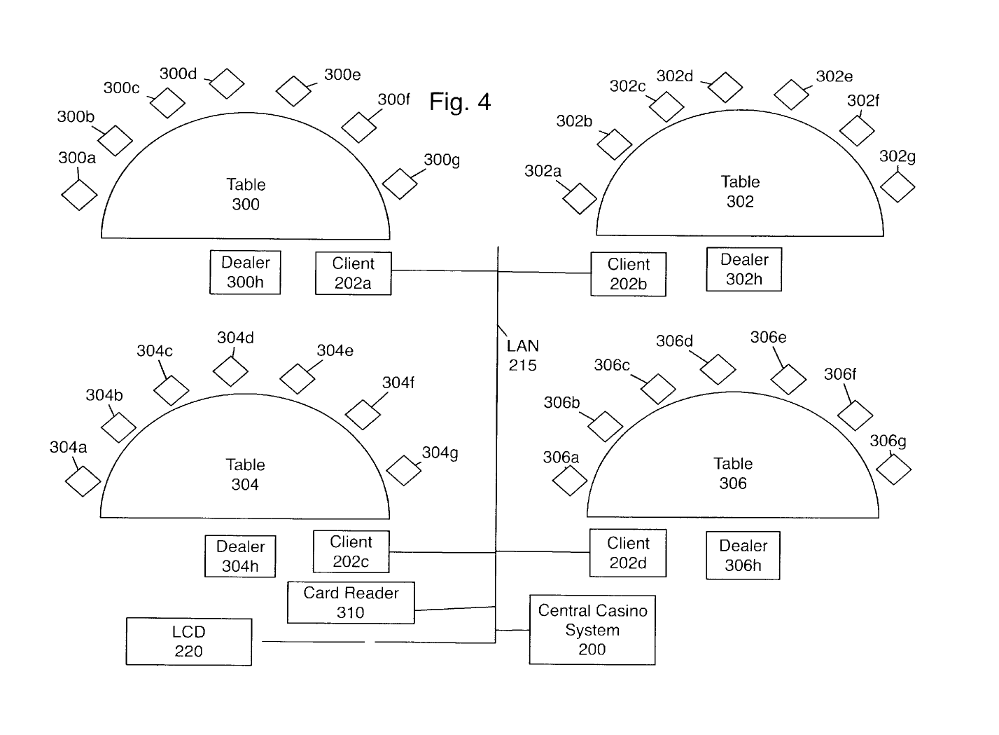

FIG. 3 depicts a block diagram of central casino system 200 of casino system 40 shown in FIG. 1. Central casino system 200 is connected to a plurality of clients 202-210 that appear at or near a game site in the casino. This is described in more detail below with respect to FIG. 4. In brief, central casino system 200 includes monitor component 200a. Monitor component 200a is used to monitor casino game availability including casino seat availability and casino betting limits and any other information obtained at a casino game site. Monitor component 200a is configured to send any and all of this information for storage in the central casino system 200 (or in an alternative embodiment, directly to central system 50 as instructed). This is described in more detail below. Monitor component 200a includes one or more software modules for execution by server (processor within) as known by those skilled in the art.

Central casino system 200 includes one or more severs that are connected to clients 202-210 through a network such as a LAN (local area network) 215 as known to those skilled in the art. These server(s) incorporate convention operating components such as processors, memory, hard drives, video cards and network interface cards. These server(s) will also incorporate conventional operating system software such as Unix, Microsoft server or other server operating systems. However, those skilled in the art know that other components networks other than LAN 215 may be used to effect desired results. A representative server is depicted in FIG. 12. Each client preferably includes a personal computer, keyboard, monitor and mouse (pointing device). Each monitor may display only or include a touch screen. The personal computers each include conventional components including a processor, memory (Random Access Memory (RAM) and Read Only Memory (ROM)), hard drive, graphics card and network card for interfacing with the network as known to those skilled in the art. The personal computers each will also include operating system (OS software) and other software applications. The OS may be Microsoft Windows 8, but other operating systems may be used.

While four clients are shown, those skilled in the art know that any number of clients may be incorporated as needed to accommodate a casino floor and the number of casino games. In addition, while clients 202-208 are shown connected to central server 200 through a network, those skilled in the art know that clients or merely dedicated terminals may be connected directly to central server 200. U.S. Pat. No. 6,672,589 to Lemke et al. discloses an example of such dedicated terminal connected directly to a central computer. U.S. Pat. No. 6,672,589 is incorporated by reference herein.

Each game site includes one or more table games. Specifically, client 202 is located in close proximity to a Black Jack table. Client 204 is located in close proximity to a Roulette table. Client 206 is located in close proximity to the Baccarat table. Client 208 is located in close proximity to a Craps table. Client 210 is located in close proximity to a Poker table. These are only examples. Those skilled in the art know that other table games (as well as non-table games such as slot machines) may work. Clients 202-210 are properly positioned to enable a pit boss or other casino employee to enter data and access data stored in central casino server 200. As discussed in more detail below, a casino employee may enter information about a player that occupies a particular space at a game. For one thing, the casino employee will immediately click on a space along a table game indicating that such space is occupied. Central server 200 will receive, store and forward such information to central system 50 to enable access to available spaces for tables in real time.

Central system 50 further includes several other systems with servers coupled to central system 200 relating to the operation of the casino including an accounting system 209 for, among other things, tracking revenue of a casino. Other systems exist that are known to those skilled in the art.

FIG. 4 depicts a top perspective view of several black jack table games at a casino shown in FIG. 1. In particular, there are four table games 300-308 shown, each of which has seven places 300a-300g, 302a-302g, 304a-304g, 306a-306g and 308a-308g, respectively for gamble reservations and play. Dealers 300h-306h deal cards for tables 300-308, respectively. In the embodiment shown in FIG. 4, four clients 202a-202d are shown, each of which is positioned adjacent one table game of the table games 300-308, respectively.

As discussed in more detail below, dealers 300h-306h each will preferably enter player data directing into a respective client. Such data shall include place seat occupancy of a table game (or table availability and limits of standing only games). Other employees may enter in such data as well. The data may be entered by keyboard, mouse or touch screen. In this case, an employee will touch the screen at the corresponding player (player) position to indicate a taken or occupied place at the table game. In other embodiments wherein only one client is used for and located in the vicinity of several tables, a pit boss, supervisor or other casino employee will monitor table place occupancy to enable real time monitoring and reservation in accordance with the present invention.

In one embodiment, a card reader may be employed for receiving player information as known to those skilled in the art. See U.S. Pat. No. 6,672,589 incorporated by reference herein. Card reader 310 is shown is shown coupled (wired or wireless) to client 202c but it may be coupled directly to central casino system 200 (wired or wireless).

In FIG. 4, there is also shown LCD 220 (liquid crystal display) coupled directly to central casino system 200 (dashed line). LCD 220 will typically be positioned at the lobby or other desired location of a casino. Central system 200 will present real time information of casino game availability including seating information as well as any other information. This is discussed in more detail below.

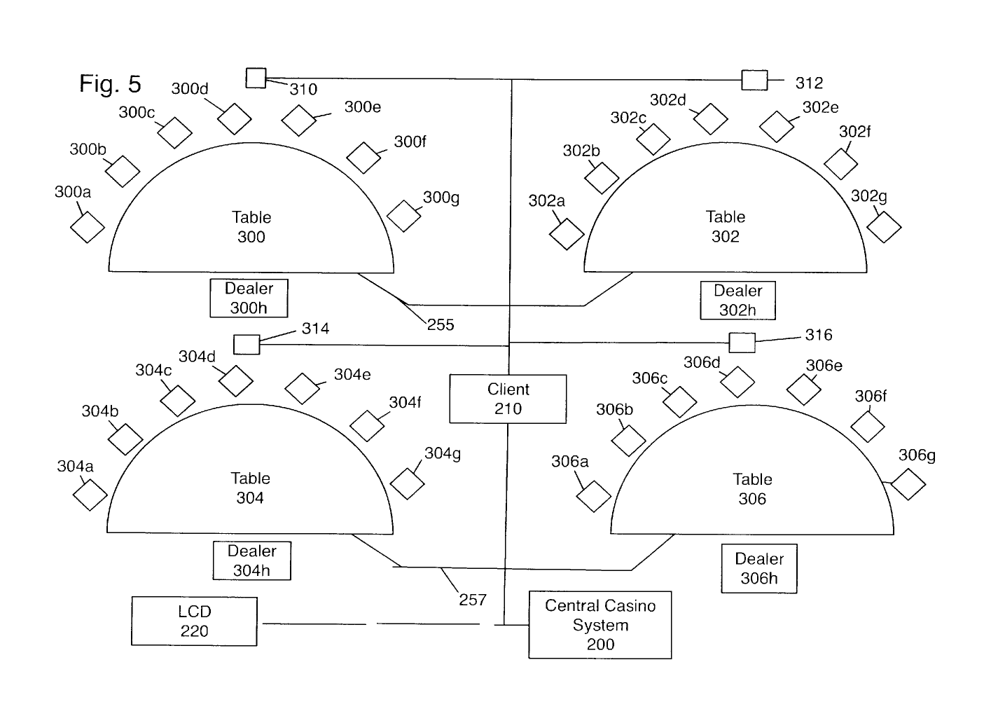

FIG. 5 depicts a top perspective view of several black jack table games at a casino shown in FIG. 3 according to another embodiment of the present invention. In particular, there are four table games 300-308 shown, each of which has seven seats (i.e., places) 300a-300g, 302a-302g, 304a-304g, 306a-306g and 308a-308g, respectively for gamble reservations and play. This is similar to that described in FIG. 4. Dealers 300h-306h deal cards for tables 300-308, respectively. In the embodiment shown in FIG. 5, only one client 210 is shown and it is located in the floor center of the table games 300-308. Further, player occupancy is determined electronically. In particular, there is shown four motion sensors 310-316, each of which is elevated above a table game 300-308 by poles or other functionally similar structures. 210. Motion sensors 312-316 are image-based sensors (i.e., cameras) connected to client 210 via a USB or other port known to those skilled in the art. In addition to motion sensors 312-316, there are seven motion sensors below table games 300-308 (not shown in FIG. 5), each of which is located in the vicinity of a seat. The motion sensors below the table are coupled to client 210 via wires or cables 255, 257. (Coupling not shown in FIG. 5.)

FIG. 5A depicts an enlarged cross sectional view of table game 300 shown in FIG. 5. In FIG. 5A, motion sensor 320 is positioned midway along the table support base. Motion sensor 320 below table game 300 surface is an infrared sensor. The infrared sensor acts as an occupancy sensor. Infrared sensor may be designed to activate image sensor 312 (for example) for data detection accuracy or image sensor 312 may activate independently. Motion sensors 310-316 and motion sensors (320) below the table game include circuitry to process the images and motion signals respectively before transmission to client 210 as known by those skilled in the art.

Image (camera) sensors 312-316 may be controlled by simple algorithm for motion detection whereby a fixed camera compares the current image with a reference image and simply counts the number of different pixels as known by those skilled in the art. Pre-processing is used to reduce false positives. Video imaging merely compares frames and generates a signal. More complex algorithms may be employed to detect motion when the image sensor (camera) actually moves, as known to those skilled in the art. Simple algorithms for using infrared motion sensors are also known to those skilled in the art. There are several algorithms currently available on the market for motion sensing capability. Blue Iris Software is one company that offers a product with this described capability.

FIG. 5B depicts an enlarged cross sectional view of the table game shown in FIG. 5 in accordance with another embodiment of the present invention. In particular, seat 300a incorporates a pressure sensor 318 within the pad itself. There is a pressure sensor within seats 300a-300g, 302a-302g, 304a-304g, 306a-306g and 308a-308g. Pressure sensor 300a includes circuitry for generating a signal when a player sits on seat 300a as known by those skilled in the art. Conventional software may be used to control these pressure sensors as known by those skilled in the art.

While the specific type and number of sensors are disclosed above, those skilled in the art know that any type or number of sensors may be employed to achieve the described monitoring. In FIG. 5, such sensors above are shown and described as directly connected to client 210. However, these sensors may communicate with client 210 wirelessly over WIFI or other wireless protocol. In addition, these sensors may be connected directly to central casino system 200 (wired or wirelessly).

Similar to FIG. 4, FIG. 5 illustrates LCD 220. It is coupled directly to central casino system 200 (dashed line). LCD 220 will typically be positioned at the lobby or other desired location of a casino. Central system 200 will present real time information of casino game availability including seating information sensed by the sensors describe above as well as any other information. This is discussed in more detail below.

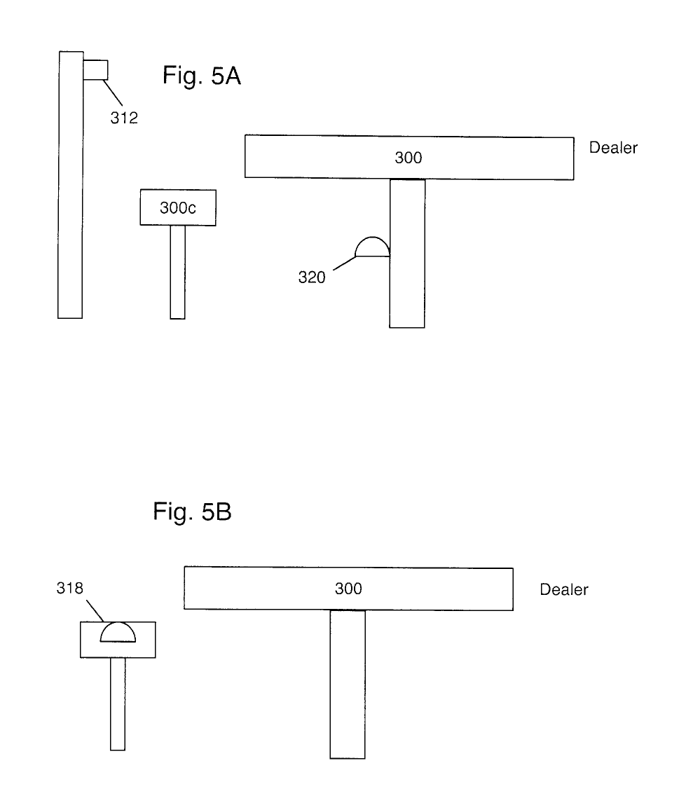

FIG. 6 depicts a top perspective view of a roulette table game 320 at the casino shown in FIG. 3. In particular, client 204 is connected to central casino system 200 and is located adjacent dealer 322. However, client 204 may be positioned in other areas on the floor accessible by the dealer, pit boss or other employee as known by those skilled in the art. There are spaces around the table for players to gather and play. The number of players is typically limited by the space around the table. If a player can squeeze into a space, the player is usually allowed to place a bet. Pit bosses typically determine when a game is available (“open”) for play and set the limits, i.e., minimum for wagering. If a table game like Roulette becomes popular, a pit boss will usually increase the betting limits for the table. Game availability including betting limits typically will be entered into client 204. In this embodiment, one table is shown but those skilled in the art know that multiple tables may be employed with one client or several clients placed in various locations on the floor.

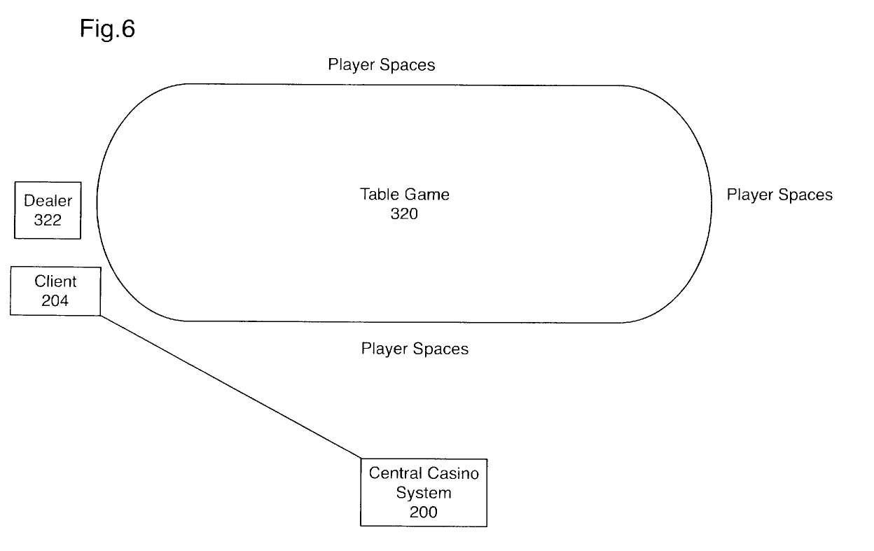

FIG. 7 depicts a block diagram of the system of FIG. 1 in part illustrating player access points in more detail. In particular, players 20-30 access applications on central system 50 through a conventional web browser, stand alone application or other software application on a device capable of accessing content from a web server or other server via Internet 60. In practice, the devices capable of accessing Internet 60 content will receive a player's request for availability of a casino game via a browser or other application and ultimately send the player's request for availability of the casino game corresponding the player's request to central system 50 as described herein.

These devices include mobile devices 400, laptops 410, desktops 420 and or other devices capable of accessing content over Internet 60. Desktops 420 and laptops are personal computers that typically access content from Internet 60 (wired or wireless) through an Internet Service Provider (ISP) as known by those skilled in the art.

Mobile devices 400 for example include cell phones, smartphones (e.g., iPhones, Android phones, etc.), PDAs, tablets (e.g., iPads) and other devices that allow a player to communicate with and access content over Internet 60 through carrier networks (e.g., Verizon, Sprint, T-Mobile, AT&T) as known by those skilled in the art. For example, U.S. Published Application No. 2007/0287413 to Kleitsch et al. describes mobile devices and content access in detail and this U.S. Published Application No. 2007/0287413 is incorporated by reference herein. Mobile devices 400 preferably incorporate similar conventional components as a personal computer (described above) including a processor, memory, storage and interface devices as known to those skilled in the art. Desktops 420 and laptops 410 include the conventional components (as described above with respect to personal computers) including processor, memory, hard drive, network interface and TCP/IP protocol stack to enable desktops 420 and laptops 410 to communicate with central system 50 over Internet 60.

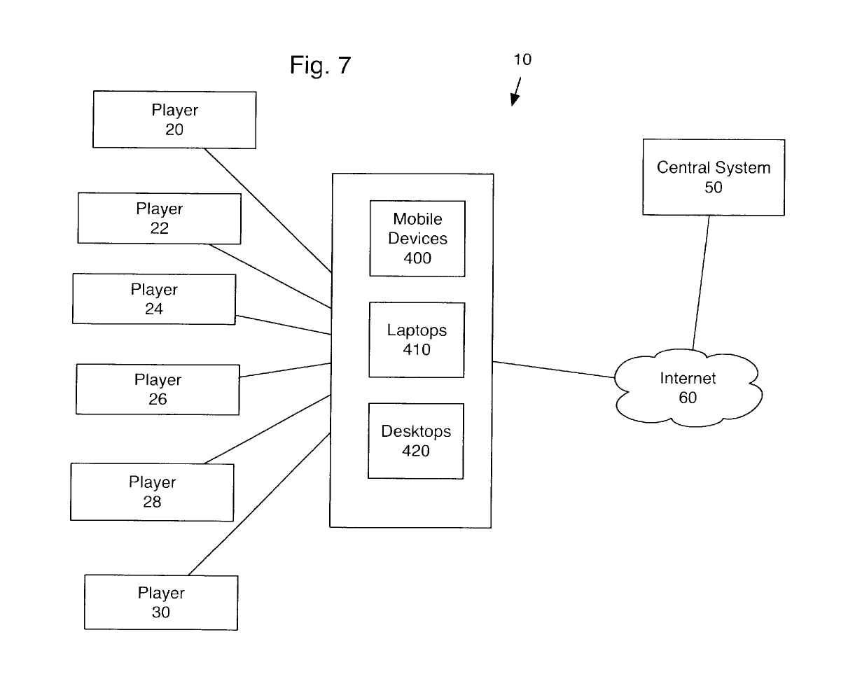

FIG. 8 depicts a flowchart of the high level steps of the application process in which a player makes a reservation. In step 500 of the process, a player enters profile information for registration. The player profile information includes identification information such as name and address, casino game preferences and other related information. Payment information may be included as well. The player may optionally enter his/her social networking information (e.g., Facebook) to enable a player to connect and search for friends, their favorite casino games and current location and game status. Registration enables a player to sign up for casino game information services and to participate in casino game and other offers. In an alternative embodiment, the registration step may be made optional. That is, the player may have the option to perform casino game reservations without registering. In addition, a player may be required to pay a fee for registration to enable the player to access the reservation system and/or receive special offers.

Now, the process moves to step 510 wherein a player selects a casino game for search and possible reservation. Alternatively, the process may initially move to step 510A, wherein the player may first search for friends on Facebook or connections on other social networking sites. The player may also search for other registrants of central system 50 that may be located in a player's geographic vicinity and/or at a specific casino game within a casino. In this case, a player's location will preferably be determined. The location information is then used to determine the location of other connections on social networking sites. Determined location information is ultimately used for other services and processes. If the player is using a mobile device, then a player's location will typically use a mobile device's location based services to determine the player's location. Location based services typically employ GPS for sensing the location of the player as known by those skilled in the art. This is called geo-sensing. If a player is accessing the application through a desktop and an Internet Service Provider, a player's IP address and access point will typically provide location information as known by those skilled in the art. Regardless of whether or not the player searches for connections on a social networking site, the player will choose a desired game to play at step 510. The desired game may be his/her own desired original game or may be the same game as one or more connections from social networking website.

At step 520, the player enters desired game variables. At this point, if the actual desired casino game is a game in which players occupy seats like Poker, then a player will enter several variables such as game price/limits, party size, desired geographical location and radius for play and desired time of play. For example, a player may enter a budgetary constraint such as $15 table limit for Black Jack. If the actual desired game is one in which players merely occupy standing space (e.g., Roulette whereby players occupy or squeeze into spaces around a table), then the player will enter a financial game constraint such as a betting limit and time of desired play and geographic location and radius. For both types of games (seated or standing/places), a player may make a request for an entire table game with premium services as discussed above. The request may be part of a configuration wherein application process will offer this option at step 510 by game choice or step 520 as a variable entry.

Regardless of the type of game, location information will also be entered manually or automatically determined if such information has not been determined already. For mobile devices for example, if the location of the player is not automatically geo-sensed (e.g., setting not activated) or the player wishes to provide a different location, the player will manually enter his/her location. For players with the option to turn-on location services, the mobile device will automatically find, present and enter a player's location information.

The process moves to step 530 wherein it is determined whether the game is a game in which seats are occupied for play. If not, then the process moves to step 540, wherein the player receives a list of available casinos including set betting limits and the process ends at box 550. However, if the game is one which seating is offered to play the game, then the process moves to step 560 wherein the player receives available casino games that match a player's variables/parameters. That is, the player will receive a list of casino games along with available seats for occupancy as well as related information. At this point, the player is asked if he/she wishes to continue at decision step 570. If the player does not wish to continue, the process ends at step 580. If the player wishes to continue, the player will acknowledge and the process will move to step 590 wherein the player will select the specific casino game and number of available seats.

The player will then enter payment information at step 600. If the player entered payment information during registration, then the player must merely confirm payment details. If not, then the player will enter credit card information or banking information. The player may alternatively enter payment information relating to virtual currency as used with Facebook and Zynga. These are only examples of payment schemes. Those skilled in the art know that other payment schemes are available to make a reservation. At step 610, the player will receive confirmation of the reservation. The process moves to step 620 wherein the player will receive special offers from the specific casino, other casinos and/or advertisers. The process ends at step 630.

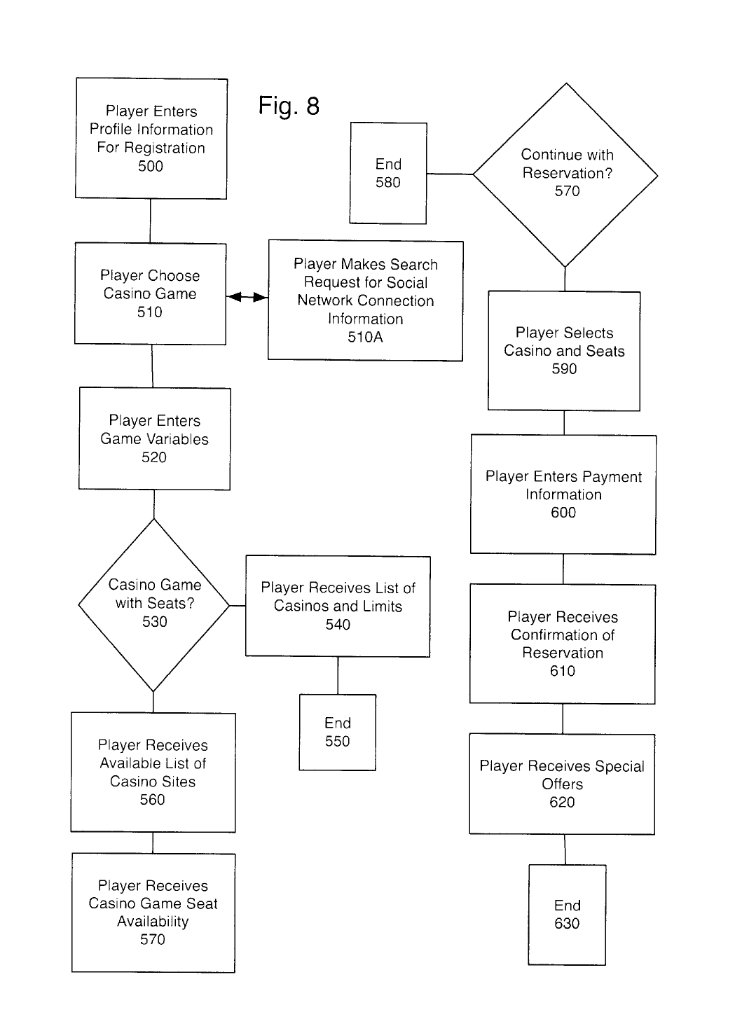

FIG. 9 depicts a flowchart of the application process of system 10 of FIG. 1 with respect to central system 50. The process begins at step 700, wherein central system 50 receives a player's registration information. Player registration component 154 handles the processing of this information and creates and sends a player profile for storage in the player profile database 162 at step 710. At this point, central system 50 may receive a direct request from a player for a particular casino game along with player variables at step 720. The variables will be based on the type of game selected as described above. For example, a player will enter party size, pricing limits, geographic location and radius for play etc. for Poker.

Now, if a player wishes to request for an table casino game for your entire party, including premiums services as described above, central system 50 will receive such a request through the application process at step 720. This can be implemented in the application, using a selected game type or using a variable entry such as a selected seats quantity. Alternatively, it may be accomplished using a specific offering or any other implementation known to those skilled in the art.

Or central system 50 may first receive a request to search for friends on Facebook or connections on other social networking sites, their locations and associated preferred or currently played casino games at step 730. At this point, a player's location will be determined at step 735 and a search will be performed as requested at step 740 and return to step 720. Location determination is described above in detail with respect to FIG. 8. Either way, central system 50 will receive a player's casino game request. It may or may not be a favorite or currently played casino game of a social network connection. Game requests are handled by game request component 150. If a player's location has not been determined already, the process will do so here at step 725.

The process moves to step 750 wherein it is determined whether the player chose a game in which seating is required or a game in which merely standing space is required. If standing space is merely required, the process moves to step 760 wherein central system 50 sends the request to multiple registered casinos. At step 770, central system 50 conducts a search for a player's requested casino game and at steps 780 and 790 receive the identified casino games and actual game betting limits that match the player's request. Games searches are handled by search engine 153. The process then ends at step 795.

If the casino game requires seating occupancy for play, then the process moves to steps 800 and 810 wherein seated casino games are searched and identified matching the player's request and variables, respectively. Again, searching is performed by search engine 152. Central system 50 then receives the identified casino games and seats availability including other information (e.g., game betting limits) from central casino system 42 at step 820. The identified casino games and available seats are then sent and presented to the player at step 830. Central system 50 then sends a request to the player asking if he/she wishes to continue at step 835. If central system 50 received an acknowledgement from the player at step 840, then the process moves to step 860 wherein central system 50 makes available to the player casino and seating selections.

At step 870, casino system 50 receives the player selection and at step 880, sends payment options to the player. Central system 50 receives the payment info from the player and sends a confirmation of the reservation at steps 890 and 900 respectively. Payment system 100 and credit card processing 110 typically performs payment processing. Central system 50 may alternatively include these components and process all payments internally. At this point, central system 50 receives a payment deposit for the reservation and retains a percentage of deposit for processing and forwards the remaining money to the reserved casino. Other payment schemes however may be used as known by those skilled in the art.

At step 910, central system 50 sends special offers to the player. The process ends at step 920. If the player does not wish to continue and says no at step 740, then the process again ends at step 850.

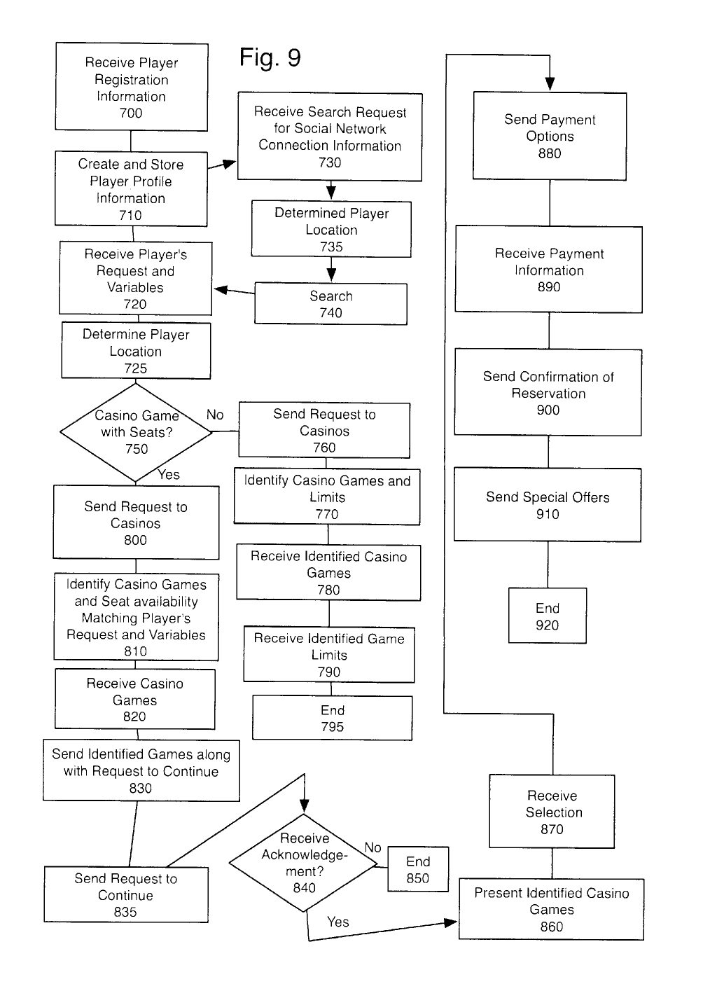

FIG. 10 depicts a flowchart of the high level steps of a part of the application process of system 10 in FIG. 1 for casino game availability including seat availability. In particular, the process steps are those performed by central casino system 42 (for seated games) shown in FIG. 3, but integrated with the process steps of the application process shown in FIG. 8. In particular, casino games are each monitored for casino game availability including seating availability at step 1000. Such information is sent to and stored in central casino system 42 at steps 1010 and 1020 respectively. These steps may be performed manually or electronically (i.e., monitoring or sensing) as described above. For example, a dealer may enter such information into a client as described above. If performed electronically, this is done automatically at predetermined times. If the monitoring is performed electronically, the step 1000 may include sensing player motion adjacent a casino game seat using image and/or infrared sensing equipment as described above. Alternatively, step 1000 may include sensing pressure (and restored pressure position) within a casino seat using pressure sensing equipment as described above. Because of the response time, seating updates are performed in real time. Casino game availability including seating information is then sent to central system 50 during as requested by search requests for casino games at step 1030 as shown in the process in FIG. 8. In addition, the same information is automatically sent to LCD 220 for a casino to display in its lobby or any other location at step 1040.

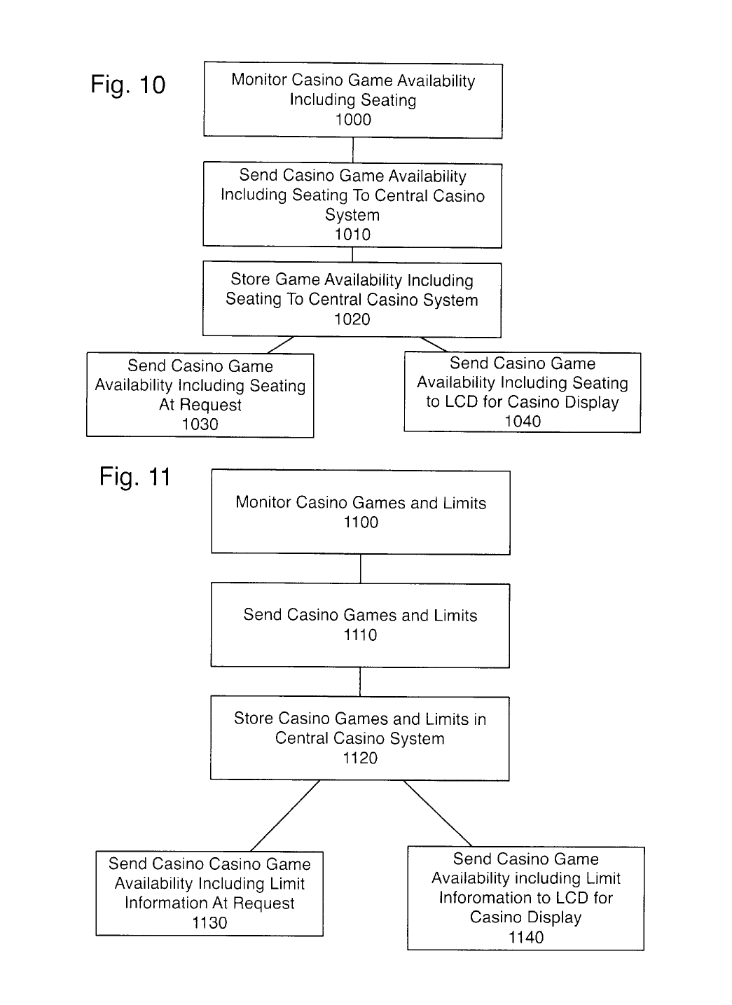

FIG. 11 depicts a flowchart of the high level steps of a part of the application process of system 10 in FIG. 1 for casino game availability including limit availability. In particular the process steps are those performed within central casino system 200 of casino system 40 of FIG. 3 (for games in which players occupy space for play). The process similarly works with the application process shown in FIG. 8. In particular, casino games including limits are monitored and such information is sent to and stored in central casino system 200 at steps 1100, 1120 and 1130 respectively. Some of these steps are performed manually as describe above. For example, dealers enter table availability (“open”) and betting limits manually into a client as described above with FIG. 5. Such information is then sent electronically to central casino system 200 for storage. Transmission is performed automatically once the dealer or other casino employee enters the information into. Seating information is used during search requests for casino games as shown in the process in FIG. 8. Casino game availability including limit information is then sent to central system 50 as requested by search requests for casino games at step 1130 as shown in the process in FIG. 8. In addition, the same information is automatically sent to LCD 220 for a casino to display in its lobby or any other location at step 1140.

While the FIGS. 8-11 depict application process steps of system 10 in accordance with the present invention, those skilled in the art know that these steps may be performed in a different order or may be performed with more or less steps. For example, the monitoring signals for casino game seating may be sent directly to central system 50 without storage within central casino system 42. Such monitored signals may be sent automatically without a request for such data.

FIG. 12 depicts a block diagram of a general purpose computer to support the embodiments of the computer-implemented systems and methods disclosed in this application. In a particular configuration, the computer 1200 is a computer server as described above that is configured to enable part or all of the execution of the software components or application steps in the embodiments in this patent application. The computer 1200 typically includes at least one processor 1210 and system memory 1220 (volatile RAM or non-volatile ROM). The system memory 1220 may include computer readable media that is accessible to the processor 1210 and may include instructions from processor 1210, an operating system 1230 and one or more application platforms 1240 such as Java and a part of a software component or one or more software components/applications 1250. The computer will include one or more communication connections such as network interfaces 1260 to enable the computer to communication with other computers over a network, storage 1270 such as a hard drives, video cards 1290 and other conventional components known to those skilled in the art. This computer 1200 typically runs Unix or Microsoft as the operating system and include TCP/IP protocol stack (to communicate) for communication over the Internet as known to those skilled in the art. A display 1280 is optionally used. Clients have similar contents as described earlier in this application.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A computer-implemented system for determining casino game availability and reserving one or more places at a casino game, the system including one or more servers configured to execute computer program components, the computer program components comprising:
a casino game request component for presenting an interface to a user via a website or other application through which player casino game requests are received; and
a reservation component for reserving one or more places at a casino game for one or more players.

2. The system of claim 1 wherein the computer program components further comprise a component for registering a player.

3. The system of claim 1 wherein the casino game request component processes a player's game request.

4. The system of claim 1 wherein the computer program components further comprise a component for monitoring casino game availability.

5. The system of claim 1 wherein the computer program components further comprises a component for monitoring casino game availability including game limits.

6. The system of claim 1 wherein the computer program components further comprises a component for monitoring casino game availability including seat availability.

7. The system of claim 4 wherein the component for monitoring casino game availability includes a component for sensing a player on or near a casino game seat.

8. The system of claim 1 wherein the one or places include one or more seats at a casino game.

9. The system of claim 1 wherein the one or more places includes one or more spaces in which one or more players may stand and play the casino game.

10. A computer-implemented method for determining casino game availability and reserving one or more places at a casino game, wherein the method is implemented in one or more servers configured to executed one or more computer program components, the method comprising:
executing, on the one or more servers, a computer program component for presenting an interface to a user via a website or other application through which player casino game requests are received; and
executing, on the one or more servers, a computer program component for reserving one or more places at a casino game for one or more players.

11. The method of claim 1 wherein the method further comprises executing, on the one or more servers, a computer program component for registering players.

12. The method of claim 10 further comprises executing, on the one or more servers, a computer program component for monitoring casino game availability.

13. The method of claim 10 further comprises executing, on the one or more servers, a computer program component monitoring casino game availability including game limits.

14. The method of claim 10 further comprises executing, on the one or more servers, a computer program component for monitoring casino game seat availability.

15. The method of claim 12 wherein the component for monitoring casino game seat availability includes a component for sensing a player on or near a casino game seat.

16. The method of claim 10 wherein the place is a seat at a casino game or a space in which a player may stand and play the casino game.

17. The method of claim 10 further comprises executing, on the one or more servers, a component for processing payment for the one or more places reserved.

18. A computer-implemented system for determining casino game availability, the system including one or more servers configured to execute one or more computer program steps, the one or more computer program steps comprising:
processing a player's request for availability of a casino game; and
searching for a casino game to play corresponding to the player's request.

19. The system of claim 18, wherein the computer program steps further comprises reserving a casino table game corresponding to the player's request.

20. The system of claim 18 wherein the computer program steps further comprises reserving casino seats corresponding to the player's request.

21. The system of claim 18 wherein the computer program steps further comprise monitoring casino game availability.

22. The system of claim 19 wherein reserving a casino table game includes reserving one or more premium services.

23. The system of claim 18 wherein the computer program steps further comprises monitoring casino game seat availability.

24. The system of claim 23 wherein the step of monitoring casino game seat availability includes the step of sensing a player on or near a casino game seat.

25. A computer-implemented method for requesting for casino game availability and for reserving places at a casino game, wherein the method is implemented in device configured to execute computer program steps, the computer program steps comprising:
receiving a player's request for availability of a casino game via a browser or other application in the device; and
sending a request for availability of the casino game corresponding to the player's request.

26. The system of claim 25 wherein the computer program steps further comprises sending a reservation for a casino game and casino seats.

27. The system of claim 25 wherein the device is a mobile device, laptop or personal computer.

28. A computer-implemented system for determining casino game availability, the system including one or more servers configured to execute computer program steps, the computer program steps comprising:
monitoring for availability of a casino game for a player to play; and
displaying the availability of the casino game to play.
